(19) United States
(12) Patent Application Publication
(10) Pub. No.: US 2023/0151145 A1
(43) Pub. Date: May 18, 2023

(54) POLYMER RESIN AND MANUFACTURING METHOD THEREOF

(71) Applicant: NAN YA PLASTICS CORPORATION, Taipei (TW)

(72) Inventors: Te-Chao Liao, Taipei (TW); Wen-Hua Lu, Taipei (TW); Chi-Lin Chen, Taipei (TW)

(73) Assignee: NAN YA PLASTICS CORPORATION, Taipei (TW)

(21) Appl. No.: 17/574,553

(22) Filed: Jan. 13, 2022

(30) Foreign Application Priority Data
Nov. 16, 2021 (TW) 110142499

(51) Int. Cl. C08G 63/199; C08G 63/672; C08G 63/78; C08K 5/56

(52) U.S. Cl. CPC C08G 63/199; C08G 63/672; C08G 63/785; C08K 5/56

(57) ABSTRACT

A polymer resin includes a copolymer of polyethylene terephthalate (PET). In the process of preparing PET, part of ethylene glycol is replaced with other components to obtain the copolymer of PET.

### CROSS-REFERENCE TO RELATED APPLICATION

This application claims the priority benefit of Taiwan application serial no. 110142499, filed on Nov. 16, 2021. The entirety of the above-mentioned patent application is hereby incorporated by reference herein and made a part of this specification.

### BACKGROUND

### Technical Field

The disclosure relates to a polymer resin, and more particularly, to a copolymer of polyethylene terephthalate (PET) and a manufacturing method thereof.

### Description of Related Art

Polyethylene terephthalate (PET) has excellent chemical resistance and electrical insulation, and has characteristics such as high strength and high rigidity. Therefore, PET is often applied to fibers, films, and plastic bottles.

Generally speaking, polyethylene terephthalate is made by esterification and polycondensation of ethylene glycol and terephthalic acid. Conventional polyethylene terephthalate has insufficient toughness and impact resistance, and is easy to change in size after being heated. Therefore, it is not suitable for engineering plastics.

### SUMMARY

The disclosure provides a polymer resin, which may improve an impact strength and thermal stability of polyethylene terephthalate.

The disclosure provides a manufacturing method of a polymer resin, which may improve the impact strength and thermal stability of polyethylene terephthalate.

At least one embodiment of the disclosure provides a polymer resin, including a copolymer of polyethylene terephthalate represented by the following Chemical Formula 1.

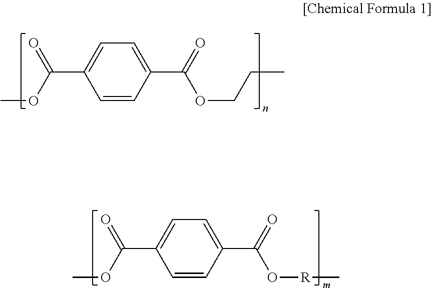

In the Chemical Formula 1, R is a residue of cycloalkane diol, where n is 1 to 20, and m is 1 to 20.

In an embodiment, R in the Chemical Formula 1 is selected from any one of the following Chemical Formula 2 to Chemical Formula 7.

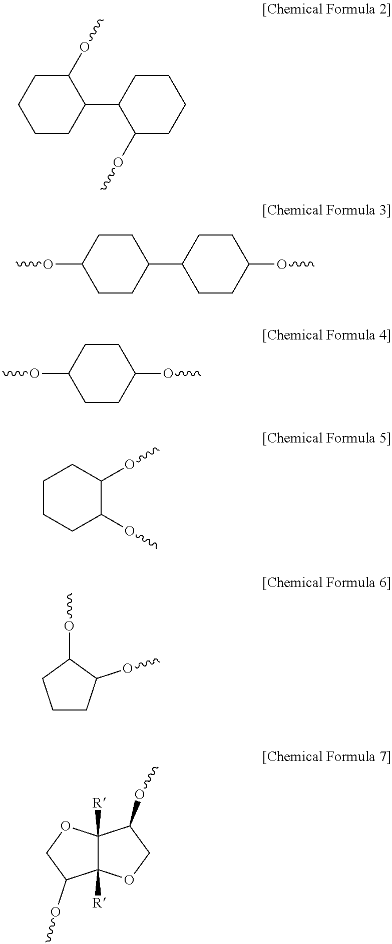

In the Chemical Formula 7, R′ is hydrogen, a benzene ring, or an alkyl group containing 1 to 4 carbons.

In an embodiment, a glass transition temperature of the copolymer of polyethylene terephthalate is greater than 80 degrees Celsius.

In an embodiment, an impact strength of the copolymer of polyethylene terephthalate is greater than 8 KJ/m².

In an embodiment, an intrinsic viscosity of the copolymer of polyethylene terephthalate is between 0.5 dl/g and 1 dl/g.

At least one embodiment of the disclosure provides a manufacturing method of a polymer resin, including the following step. A polymerization reaction on ethylene glycol, terephthalic acid, and cycloalkane diol is performed to obtain a copolymer of polyethylene terephthalate represented by the following Chemical Formula 1.

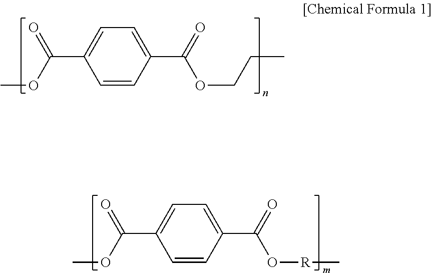

In the Chemical Formula 1, R is a residue of cycloalkane diol, where n is 1 to 20, and m is 1 to 20.

In an embodiment, the cycloalkane diol is selected from any one of the following Chemical Formula 8 to Chemical Formula 13.

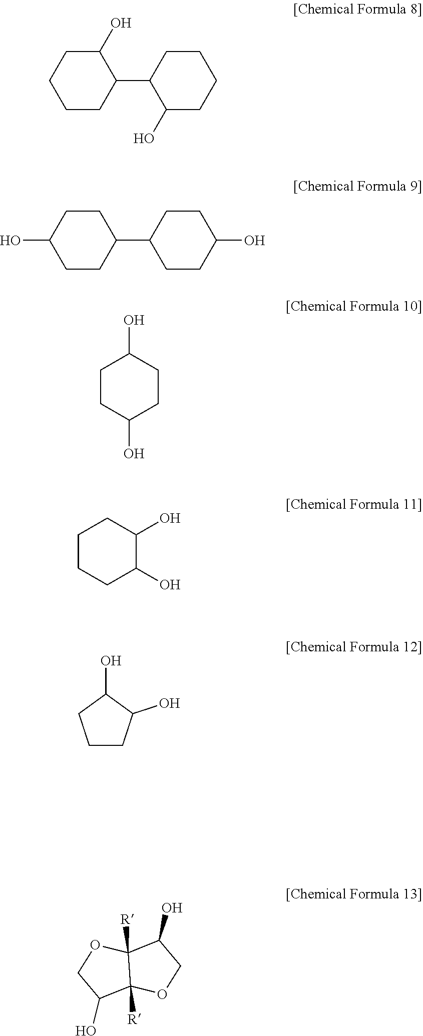

In the Chemical Formula 13, R′ is hydrogen, a benzene ring, or an alkyl group containing 1 to 4 carbons.

In an embodiment, performing the polymerization reaction on the ethylene glycol, the terephthalic acid, and the cycloalkane diol includes the following steps. The ethylene glycol, the terephthalic acid, and the cycloalkane diol adding are added into an esterification tank, and the esterification tank is heated. An esterification reaction is performed on the ethylene glycol, the terephthalic acid, and the cycloalkane diol in the esterification tank under an atmospheric pressure to remove excess water in the esterification tank, and an esterified product is generated. The esterified product is moved to a polycondensation tank, and a normal pressure pre-polymerization reaction is performed on the esterified product. Pressure in the polycondensation tank is gradually reduced from the atmospheric pressure to 20 torr, and the polycondensation tank is heated. The pressure in the polycondensation tank is reduced from 20 torr to 1 torr.

In an embodiment, the manufacturing method further includes a catalyst, an antioxidant, and tetraisopropyl titanate are added into the poly condensation tank.

In an embodiment, a glass transition temperature of the copolymer of polyethylene terephthalate is greater than 80 degrees Celsius, and an impact strength is greater than 8 KJ/m².

### BRIEF DESCRIPTION OF THE DRAWINGS

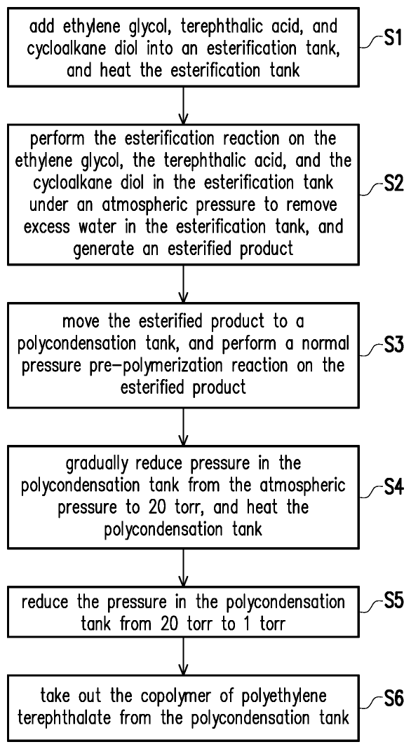

The FIG. 1s a flowchart of a manufacturing method of a polymer resin according to an embodiment of the disclosure.

### DETAILED DESCRIPTION OF DISCLOSED EMBODIMENTS

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

In an embodiment of the disclosure, a polymerization reaction is performed on ethylene glycol (EG), terephthalic acid (PTA), and cycloalkane diol to obtain a copolymer of polyethylene terephthalate represented by the following Chemical Formula 1.

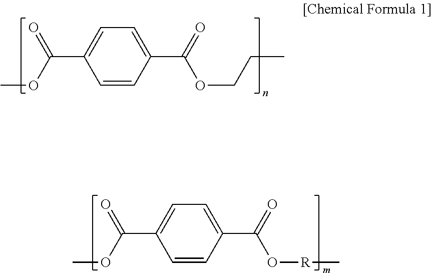

In the Chemical Formula 1, R is a residue of cycloalkane diol, where n is 1 to 20, and m is 1 to 20.

In some embodiments, R in the Chemical Formula 1 is selected from any one of the following Chemical Formula 2 to Chemical Formula 7.

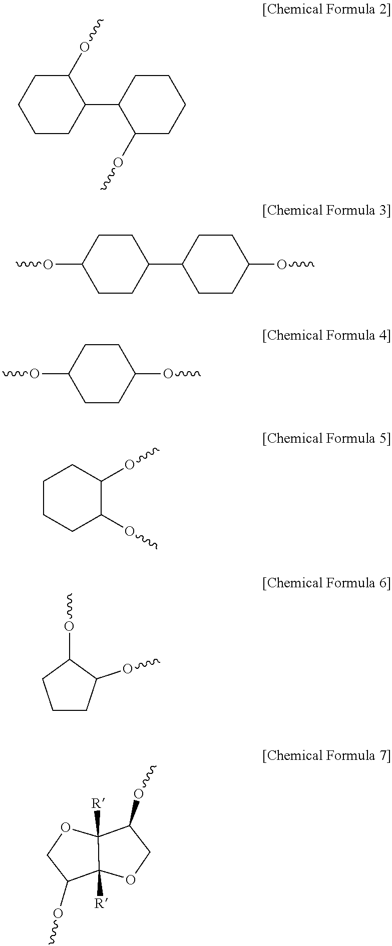

In the Chemical Formula 7, R′ is hydrogen, a benzene ring, or an alkyl group containing 1 to 4 carbons.

In some embodiments, when the copolymer of polyethylene terephthalate is synthesized, the cycloalkane diol which is used may be selected from the following Chemical Formula 8 to Chemical Formula 13.

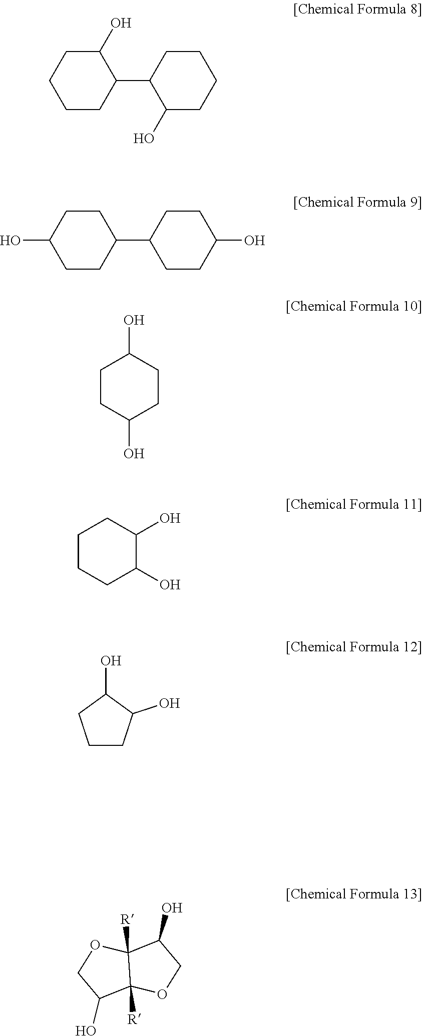

In the Chemical Formula 13, R′ is hydrogen, the benzene ring, or the alkyl group containing 1 to 4 carbons.

In this embodiment, the cycloalkane diol is used to replace part of the ethylene glycol to synthesize the copolymer of polyethylene terephthalate. Therefore, the copolymer of polyethylene terephthalate includes more cycloalkane structures than conventional polyethylene terephthalate. As a result, the synthesized copolymer of polyethylene terephthalate has a higher glass transition temperature and higher impact strength. For example, the glass transition temperature of the copolymer of polyethylene terephthalate represented by the Chemical Formula 1 is greater than 80 degrees Celsius, and the impact strength is greater than 8 KJ/m².

The FIG. 1s a flowchart of a manufacturing method of a polymer resin according to an embodiment of the disclosure.

In this embodiment, the manufacturing method of the polymer resin includes reactions such as an esterification reaction and a polycondensation reaction.

Referring to the FIGURE, the esterification reaction includes step S1 and step S2. In step S1, the ethylene glycol, the terephthalic acid, and the cycloalkane diol are added into an esterification tank, and the esterification tank is heated (for example, heated to 230 degrees Celsius to 280 degrees Celsius, preferably to 230 degrees to 260 degrees Celsius). In some embodiments, 90 to 100 moles of terephthalic acid, 20 to 50 moles of ethylene glycol, and 20 to 50 moles of cycloalkane diol are added into the esterification tank, but the disclosure is not limited thereto. An amount of ethylene glycol, terephthalic acid, and cycloalkane diol may be adjusted according to actual requirements. In step S2, the esterification reaction is performed on the ethylene glycol, the terephthalic acid, and the cycloalkane diol in the esterification tank under a normal pressure (an atmospheric pressure) to remove excess water in the esterification tank, and an esterified product is generated. For example, the esterification reaction is a normal pressure esterification reaction, and the normal pressure esterification reaction is, for example, performed for 4 hours.

After the normal pressure esterification reaction is performed (for example, after a water output of the esterification reaction reaches a target value), the polycondensation reaction is performed. The polycondensation reaction includes step S3, step S4, and step S5. In step S3, the esterified product is moved to a polycondensation tank, and a normal pressure pre-polymerization reaction is performed. In some embodiments, a reaction temperature of the pre-polymerization reaction is, for example, 230 degrees Celsius to 280 degrees Celsius, preferably heated to 230 degrees Celsius to 260 degrees Celsius. In some embodiments, the normal pressure pre-polymerization reaction is, for example, performed for 1 hour. In some embodiments, in step S3, it further includes that an additive is added into the polycondensation tank, such as a catalyst (e.g. antimony trioxide), an antioxidant (e.g. triphenyl phosphate (TPP)), and tetraisopropyl titanate (TIPT). Next, in step S4, pressure in the polycondensation tank is gradually reduced from the atmospheric pressure to 20 torr, and the polycondensation tank is heated. In some embodiments, in step S4, the pressure in the polycondensation tank is reduced at a rate of 10 torr to 30 torr per minute, and the polycondensation tank is heated to 265 degrees to 280 degrees Celsius. Then, in step S5, the pressure in the polycondensation tank is reduced from 20 torr to 1 torr, and the polycondensation reaction is performed. In some embodiments, the polycondensation reaction is performed for 1 hour.

Finally, in step S6, the copolymer of polyethylene terephthalate is taken out from the polycondensation tank. For example, nitrogen gas is introduced into the polycondensation tank, and the synthesized copolymer of polyethylene terephthalate is extruded out from the polycondensation tank under pressure of the nitrogen gas. Next, particles of the copolymer of polyethylene terephthalate are obtained through processes such as water cooling, bracing, and dicing. In some embodiments, an intrinsic viscosity of the copolymer of polyethylene terephthalate is between 0.5 dl/g and 1 dl/g.

Based on the above, the cycloalkane diol is used to replace part of the ethylene glycol to synthesize the copolymer of polyethylene terephthalate. Therefore, the copolymer of polyethylene terephthalate includes more cycloalkane structures than the conventional polyethylene terephthalate. As a result, the synthesized copolymer of polyethylene terephthalate has the higher glass transition temperature and the higher impact strength.

Hereinafter, some examples of the copolymer of polyethylene terephthalate in the disclosure are provided. However, these examples are illustrative, and the disclosure is not limited thereto.

### Example 1

498 g of terephthalic acid, 130.2 g of ethylene glycol, and 396.7 g of [1,1′-Bi(cyclohexane)]-2,2′-diol (as the Chemical Formula 8) are put into a batching tank to be fully stirred, so as to obtain a slurry. In the slurry of Example 1, a molar ratio of ethylene glycol to [1,1′-Bi(cyclohexane)]-2,2′-diol is 1:1, and a molar ratio of acid to alcohol in the slurry is 1:1.05 to 1:1.5.

The esterification reaction is performed on the slurry under the normal pressure for 4 hours, and a temperature of the esterification reaction is controlled at 230 degrees Celsius to 280 degrees Celsius. Next, the esterified product formed after the esterification reaction is moved to the polycondensation tank. Based on a total weight of the esterified product, antimony trioxide of 0.1 wt %, tetraisopropyl titanate of 0.1 wt %, and triphenyl phosphate of 0.1 wt % are added respectively, and the normal pressure pre-polymerization is performed for 1 hour. Then, the pressure in the polycondensation tank is gradually reduced to 20 torr, and a temperature of the polycondensation tank is increased to 265 degrees Celsius to 280 degrees Celsius. Afterwards, the pressure in the polycondensation tank is reduced to 1 torr, and the polycondensation reaction is performed for 1 hour. Finally, the nitrogen gas is introduced into the polycondensation tank, and the synthesized copolymer of polyethylene terephthalate is extruded out from the polycondensation tank under the pressure of the nitrogen gas. Next, the particles of the copolymer of polyethylene terephthalate are obtained through the processes such as water cooling, bracing, and dicing.

### Example 2 to Example 6

In the same manner as in Example 1, the copolymer of polyethylene terephthalate is synthesized. A difference between Example 2 to Example 6 and Example 1 is that other cycloalkane diol is used in Example 2 to Example 6 to replace [1,1′-Bi(cyclohexane)]-2,2′-diol in Example 1. Specifically, in Example 2, 396.6 g of [1,1′-bicyclohexyl]-4,4′-diol is used (as the Chemical Formula 9). In Example 3, 209.1 g of 1,4-Cyclohexanediol is used (as the Chemical Formula 10). In Example 4, 209.2 g of 1,2-Cyclohexanediol is used (as the Chemical Formula 11). In Example 5, 185.4 g of 1,2-Cyclopentanediol is used (as the Chemical Formula 12). In Example 6, 271.6 g of isosorbide is used (as the Chemical Formula 13 where R′ is hydrogen).

Physical properties of the copolymers of polyethylene terephthalate synthesized in Example 1 to Example 6 and the conventional polyethylene terephthalate (a comparative example) are provided in Table 1.

TABLE 1

| | Example | Example | Example | Example | Example | Example | Comparative |
|---|---|---|---|---|---|---|---|
| | 1 | 2 | 3 | 4 | 5 | 6 | example |
| Tg(° C.) | 90.2 | 100 | 87 | 87 | 88 | 87 | 78.3 |
| Impact | 15.9 | 14.0 | 12.5 | 9.1 | 11.9 | 8.7 | 3.5 |
| strength | | | | | | | |
| (KJ/m²) | | | | | | | |
| Flexural | 2608 | 2323 | 2169 | 2091 | 2218 | 2011 | 2560 |
| modulus | | | | | | | |
| (MPa) | | | | | | | |
| Intrinsic | 0.73 | 0.66 | 0.72 | 0.68 | 0.72 | 0.75 | 0.76 |
| viscosity | | | | | | | |
| (dl/g) | | | | | | | |

It may be seen from Table 1 that the copolymers of polyethylene terephthalate synthesized in Example 1 to Example 6 have the higher glass transition temperature and the higher impact strength than the conventional polyethylene terephthalate.

What is claimed is:

1. A polymer resin, comprising a copolymer of polyethylene terephthalate represented by the following Chemical Formula 1, 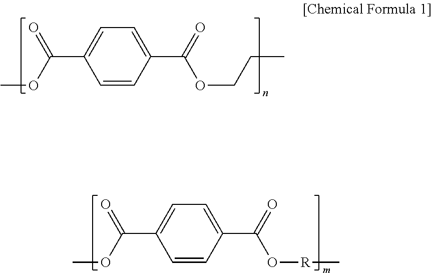
wherein in the Chemical Formula 1, R is a residue of cycloalkane diol, n is 1 to 20, and m is 1 to 20.

2. The polymer resin according to claim 1, wherein R in the Chemical Formula 1 is selected from any one of the following Chemical Formula 2 to Chemical Formula 7, 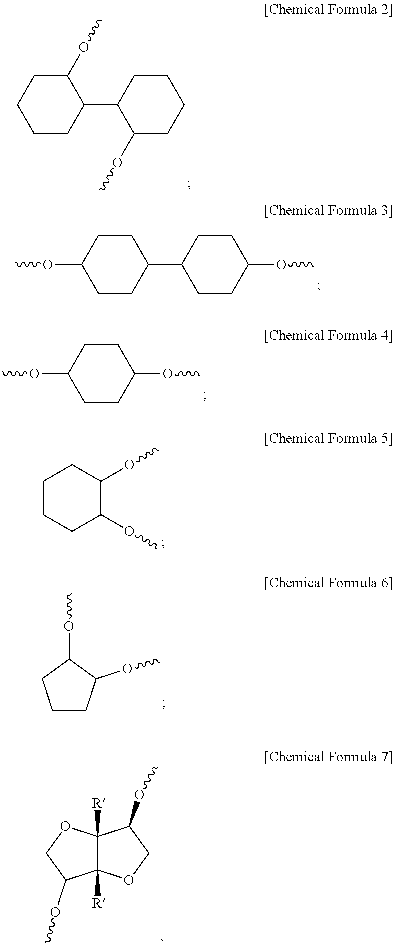
wherein in the Chemical Formula 7, R′ is hydrogen, a benzene ring, or an alkyl group containing 1 to 4 carbons.

3. The polymer resin according to claim 1, wherein a glass transition temperature of the copolymer of polyethylene terephthalate is greater than 80 degrees Celsius.

4. The polymer resin according to claim 1, wherein an impact strength of the copolymer of polyethylene terephthalate is greater than 8 KJ/m².

5. The polymer resin according to claim 1, wherein an intrinsic viscosity of the copolymer of polyethylene terephthalate is between 0.5 dl/g and 1 dl/g.

6. A manufacturing method of a polymer resin, comprising:
performing a polymerization reaction on ethylene glycol, terephthalic acid, and cycloalkane diol to obtain a copolymer of polyethylene terephthalate represented by the following Chemical Formula 1, 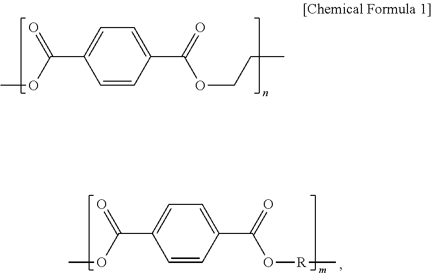
wherein in the Chemical Formula 1, R is a residue of cycloalkane diol, n is 1 to 20, and m is 1 to 20.

7. The manufacturing method of the polymer resin according to claim 6, wherein the cycloalkane diol is selected from any one of the following Chemical Formula 8 to Chemical Formula 13, 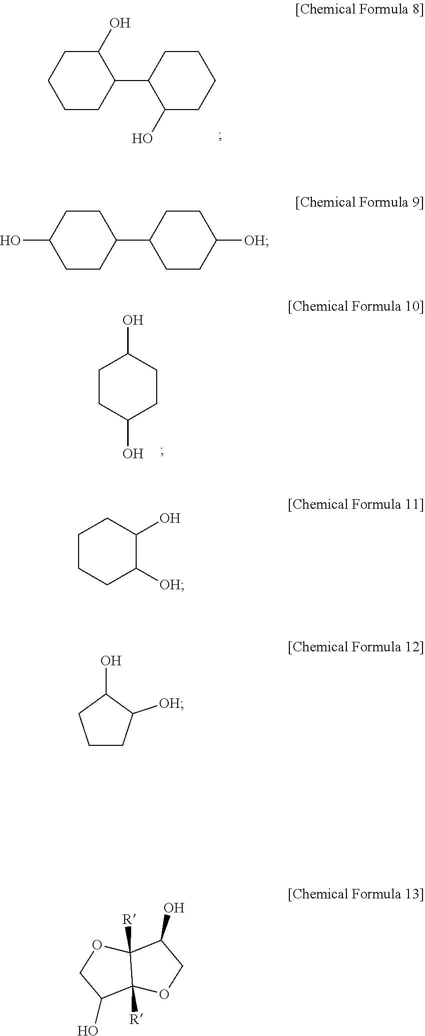
where in the Chemical Formula 13, R′ is hydrogen, a benzene ring, or an alkyl group containing 1 to 4 carbons.

8. The manufacturing method of the polymer resin according to claim 6, wherein performing the polymerization reaction on the ethylene glycol, the terephthalic acid, and the cycloalkane diol comprises:
adding the ethylene glycol, the terephthalic acid, and the cycloalkane diol into an esterification tank, and heating the esterification tank;
performing an esterification reaction on the ethylene glycol, the terephthalic acid, and the cycloalkane diol in the esterification tank under an atmospheric pressure to remove excess water in the esterification tank, and generating an esterified product;
moving the esterified product to a polycondensation tank, and performing a normal pressure pre-polymerization reaction on the esterified product;
gradually reducing pressure in the polycondensation tank from the atmospheric pressure to 20 torr, and heating the polycondensation tank; and
reducing the pressure in the polycondensation tank from 20 torr to 1 torr.

9. The manufacturing method of the polymer resin according to claim 8, further comprising:
adding a catalyst, an antioxidant, and tetraisopropyl titanate into the polycondensation tank.

10. The manufacturing method of the polymer resin according to claim 8, wherein a glass transition temperature of the copolymer of polyethylene terephthalate is greater than 80 degrees Celsius, and an impact strength is greater than 8 KJ/m².
